(19) United States
(12) Patent Application Publication
(10) Pub. No.: US 2026/0342484 A1
(43) Pub. Date: Oct. 29, 2026

(54) Supporting High Reliability Low Power XR

(71) Applicant: InterDigital Patent Holdings, Inc., Wilmington, DE (US)

(72) Inventors: Tejaswinee Lutchoomun, Montreal (CA); Jaya Rao, Montreal (CA); Senay Negusse, Montreal (CA); Benoit Pelletier, Roxboro (CA)

(73) Assignee: InterDigital Patent Holdings, Inc., Wilmington, DE (US)

(21) Appl. No.: 19/116,050

(22) PCT Filed: Sep. 28, 2023
(86) PCT No.: PCT/US2023/033995

§ 371 Date: Mar. 27, 2025

Related U.S. Application Data
(60) Provisional application No. 63/410,862, filed on Sep. 28, 2022.
(60) Provisional application No. 63/529,549, filed on Jul. 28, 2023.

(51) Int. Cl. H04L 1/1812; H04W 72/1268; H04W 72/231; H04W 76/20

(52) U.S. Cl. CPC H04L 1/1812; H04W 72/1268; H04W 72/231; H04W 76/20

(57) ABSTRACT

Systems, methods, and instrumentalities are described herein for supporting high reliability low power extended reality (XR). A wireless transmit/receive unit (WTRU) may perform actions, for example, to maximize operation in a low power state (e.g., RRC Inactive state) while meeting requirements for XR traffic (e.g., high reliability, low latency, high throughput). The WTRU may perform actions to make inactive state data transmissions (e.g., SDT) more deterministic, adapted to XR traffic. The WTRU may determine the reliability for sending data in the UL while remaining in a low power state, for example, based on traffic information or priority information associated with data.

### CROSS-REFERENCE TO RELATED APPLICATIONS

This application claims the benefit of Provisional U.S. Patent Application No. 63/410,862, filed Sep. 28, 2022, and Provisional U.S. Patent Application No. 63/529,549, filed Jul. 28, 2023, the disclosures of which are incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for supporting high reliability low power extended reality (XR). A wireless transmit/receive unit (WTRU) may perform actions, for example, to maximize operation in a low power state (e.g., RRC Inactive state) while meeting requirements for XR traffic (e.g., high reliability, low latency, high throughput). The WTRU may perform actions to make inactive state data transmissions (e.g., SDT) more deterministic, adapted to XR traffic. The WTRU may determine the reliability for sending data in the UL while remaining in a low power state, for example, based on traffic information or priority information associated with data.

A WTRU may support high reliability for transmissions while in inactive operation. The WTRU may receive configuration information for operation in an inactive state (e.g., RRC INACTIVE). The configuration information may indicate one or of the following: threshold(s); hybrid automatic repeat request (HARQ) configuration identifications (IDs); association information; configured grant small data transmission (CG-SDT) resource(s) associated with inactive state; and/or the like. The association information may associate a (e.g., each) HARQ configuration ID to a respective threshold. A (e.g., each) HARQ configuration ID may be associated with a respective feedback parameter (e.g., slot number, monitoring periodicity, etc.). The (e.g., each) threshold(s) may be a priority threshold (e.g., priority value threshold, PDU set importance threshold). The WTRU may determine a protocol data unit (PDU) set and a value associated with the PDU set (e.g., importance value associated with the PDU set). The WTRU may select (e.g., while operating in the inactive state) a HARQ configuration ID, for example, based on the value associated with the PDU set, the association information, and the thresholds. The WTRU may send (e.g., to a base station) an indication (e.g., first indication) that indicates the selected HARQ configuration ID and the PDU set. The indication may be sent using a CG-SDT resource (e.g., indicated in the configuration information)

The WTRU may monitor for feedback based on the selected HARQ configuration. For example, the selected HARQ configuration may be associated with a feedback parameter, such as, for example, a slot number or a monitoring periodicity. The WTRU may receive feedback using the feedback parameter associated with the selected HARQ configuration ID. The feedback may be an acknowledgement (ACK) or a negative acknowledgement (NACK). The WTRU may determine to send a second indication, for example, based on the received feedback. The WTRU may send the second indication, for example, if the received feedback is a NACK. The second indication may indicate the PDU set (e.g., repeat transmission of the PDU set).

The WTRU may select the HARQ configuration ID, for example, based on a property associated with the PDU set. The WTRU may select the HARQ configuration ID based on the value associated with the PDU set and the property associated with the PDU set. The property associated with the PDU set may include one or more of the following: a PDU set type; a PDU set size; a number of PDUs in the PDU set; and/or the like.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates example cases of transmissions between a WTRU and a base station for XR.

FIG. 3 illustrates an example legacy system not receiving feedback from a gNB.

FIG. 4 illustrates an example HARQ feedback adaptation.

### DETAILED DESCRIPTION

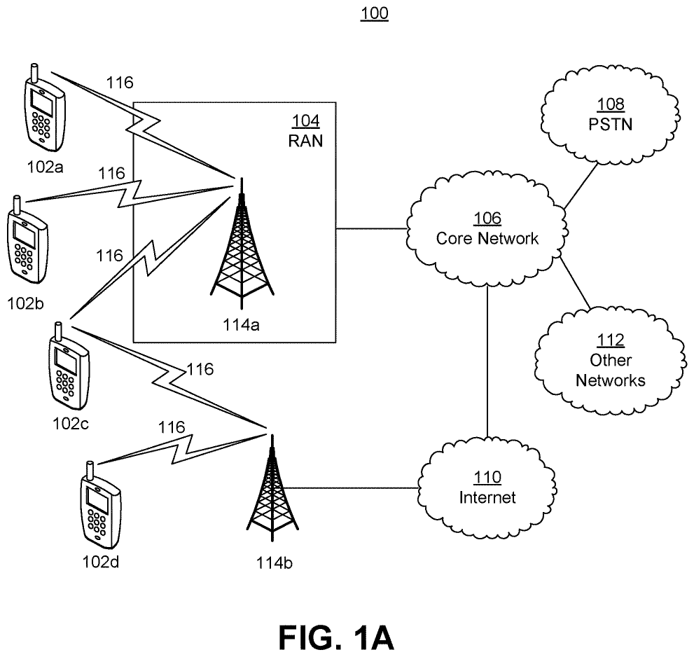

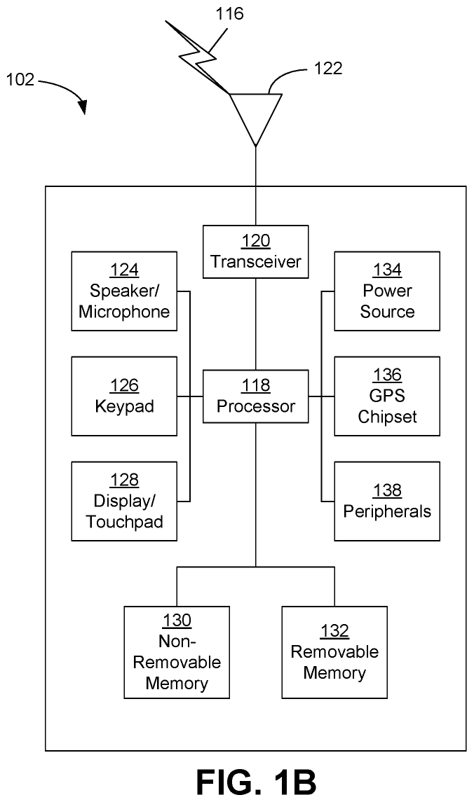

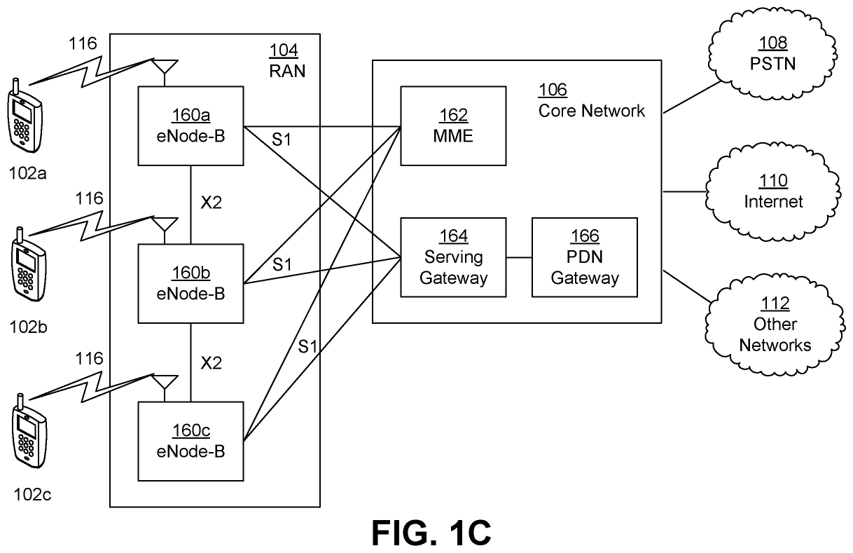

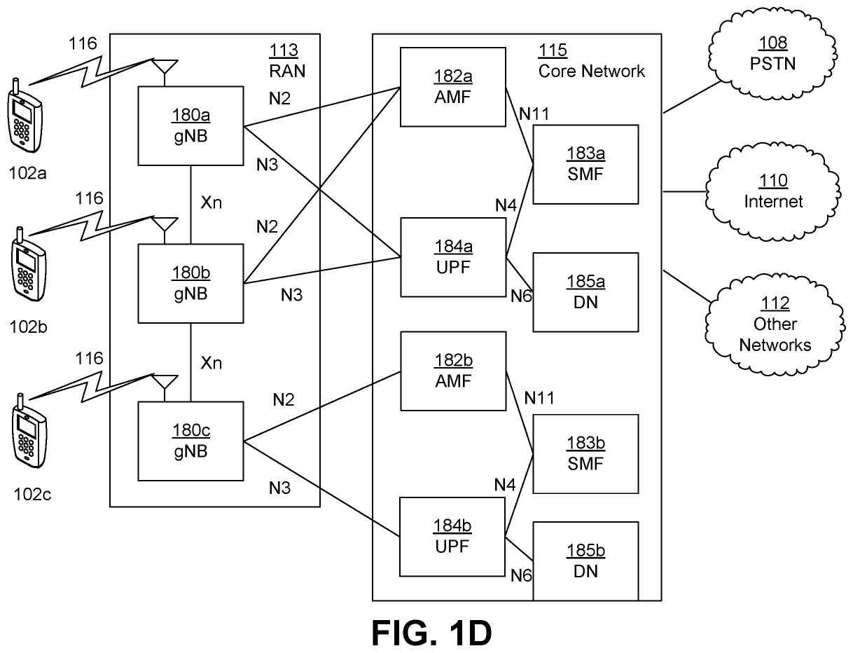

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for supporting high reliability low power extended reality (XR). A wireless transmit/receive unit (WTRU) may perform actions, for example, to maximize operation in a low power state (e.g., RRC Inactive state) while meeting requirements for XR traffic (e.g., high reliability, low latency, high throughput). The WTRU may perform actions to make inactive state data transmissions (e.g., SDT) more deterministic, adapted to XR traffic. The WTRU may determine the reliability for sending data in the UL while remaining in a low power state, for example, based on traffic information or priority information associated with data.

A WTRU may support high reliability for transmissions while in inactive operation. The WTRU may receive configuration information for operation in an inactive state (e.g., RRC INACTIVE). The configuration information may indicate one or of the following: threshold(s); hybrid automatic repeat request (HARQ) configuration identifications (IDs); association information; configured grant small data transmission (CG-SDT) resource(s) associated with inactive state; and/or the like. The association information may associate a (e.g., each) HARQ configuration ID to a respective threshold. A (e.g., each) HARQ configuration ID may be associated with a respective feedback parameter (e.g., slot number, monitoring periodicity, etc.). The (e.g., each) threshold(s) may be a priority threshold (e.g., priority value threshold, PDU set importance threshold). The WTRU may determine a protocol data unit (PDU) set and a value associated with the PDU set (e.g., importance value associated with the PDU set). The WTRU may select (e.g., while operating in the inactive state) a HARQ configuration ID, for example, based on the value associated with the PDU set, the association information, and the thresholds. The WTRU may send (e.g., to a base station) an indication (e.g., first indication) that indicates the selected HARQ configuration ID and the PDU set. The indication may be sent using a CG-SDT resource (e.g., indicated in the configuration information)

The WTRU may monitor for feedback based on the selected HARQ configuration. For example, the selected HARQ configuration may be associated with a feedback parameter, such as, for example, a slot number or a monitoring periodicity. The WTRU may receive feedback using the feedback parameter associated with the selected HARQ configuration ID. The feedback may be an acknowledgement (ACK) or a negative acknowledgement (NACK). The WTRU may determine to send a second indication, for example, based on the received feedback. The WTRU may send the second indication, for example, if the received feedback is a NACK. The second indication may indicate the PDU set (e.g., repeat transmission of the PDU set).

The WTRU may select the HARQ configuration ID, for example, based on a property associated with the PDU set. The WTRU may select the HARQ configuration ID based on the value associated with the PDU set and the property associated with the PDU set. The property associated with the PDU set may include one or more of the following: a PDU set type; a PDU set size; a number of PDUs in the PDU set; and/or the like.

Enhancements to support reliable transmissions may be performed proactively. A WTRU may be in an inactive state (e.g., RRC Inactive State). A WTRU may receive configuration information (e.g., from a base station) for operating in an inactive state (e.g., CG-SDT resources and importance thresholds corresponding to PDU-sets or groups of PDU-sets). The WTRU may receive one or more PDU-set(s) to send in UL. The WTRU may receive an indication (e.g., from an application) indicating an importance of a payload (e.g., on a PDU-set or group of PDU-sets basis). The WTRU may determine whether to flag data for high reliability, for example, based on an indication from the application and the thresholds indicated by the base station. For example, if the importance of the UL payload is greater than the threshold, the WTRU may send data with a flag indicating a request for feedback (e.g., in the header of a first PDU or PDU-set or header of a fist PDU-set in a group of PDU-sets, e.g., data burst). If the importance of the UL payload is less than the threshold, the WTRU may send the data without a flag.

Enhancements to support reliable transmissions may be performed reactively. A WTRU may be in an inactive state (e.g., RRC Inactive State). The WTRU may receive configuration information (e.g., from a base station) for operating in an inactive state (e.g., CG-SDT resources). The WTRU may receive one or more PDU-set(s) to send in UL. The WTRU may receive an indication (e.g., from an application) indicating an importance associated with the PDU-set(s). The WTRU may send the PDU-set(s) in UL. The WTRU may fit the PDU-set(s) in a CG-SDT UL grant. The WTRU may perform segmentation of the PDU-set(s) to fit into multiple CG-SDT slots/transmission cycles. The WTRU may determine a number of CG-SDT transmissions (e.g., x number of transmissions), for example, after which it requests (e.g., needs) feedback from the NW (e.g., based on the importance of the PDU-set(s)/data burst). The WTRU may send to the base station a request for ACK for x number of CG-SDT transmissions, for example, if the WTRU does not receive feedback from the base station (e.g., after x CG-SDT transmissions).

Enhancements to support reliable transmissions may be performed associated with proactive data duplication. A WTRU may be in an inactive state (e.g., RRC Inactive State). The WTRU may receive configuration information (e.g., from a base station) for operating in an inactive state (e.g., CG-SDT resources, an importance threshold(s) corresponding to PDU-sets or groups of PDU-sets). The WTRU may receive one or more PDU-set(s) to send in the uplink. The WTRU may receive an indication (e.g., from an application) associated with the importance of the payload (e.g., on a PDU-set or group of PDU-sets basis). The WTRU may determine whether to duplicate data with high reliability (e.g., based on an indication from the application and the base station threshold). The WTRU may duplicate the threshold, for example, if the importance of the UL payload is greater than the threshold. The WTRU may send the data without duplication, for example, if the importance of the UL payload is less than the threshold.

Enhancements to support reliable transmissions may be performed associated with a high reliability. A WTRU may be in an inactive state (e.g., RRC Inactive State). The WTRU may receive configuration information (e.g., from a base station) for operating in an inactive state (e.g., CG-SDT resources, importance thresholds corresponding to PDU-sets or groups of PDU-sets). The WTRU may receive one or more PDU-set(s) to send in the UL. The WTRU may receive an indication (e.g., from the application) associated with the importance of the payload (e.g., on a PDU-set or group of PDU-sets basis). The WTRU may determine whether to duplicate data with high reliability or use ACK/NACK, for example, based on reliability. The WTRU may use ACK/NACK to send the data, for example, if the importance of the UL payload is greater than the threshold and the PDB of the UL payload is greater than the delay threshold. The WTRU may duplicate the data in the payload, for example, if the importance of the UL payload is greater than the threshold and the PDB of the UL payload is less than the delay threshold.

Adapted feedback (e.g., HARQ) may be configured, for example, for a WTRU operating in (e.g., for when a WTRU is operating in) an inactive state. High reliability PDU set transmissions may be supported while operating in a low power state (e.g., inactive state). For example, a WTRU may receive configuration information indicating to operate in INACTIVE state. The configuration information may indicate one or more of the following: resources (e.g., CG-SDT) resources, importance thresholds, one or more HARQ configurations to use in INACTIVE state, association information between HARQ configuration and PDU set importance (PSI), etc. The WTRU may receive data (e.g., from the application in the WTRU), for example, such as PDU sets and their corresponding PSI. The WTRU may select (e.g., while operating in an inactive state) a HARQ configuration, for example, based on the PSI and the association information. The WTRU may send, to the network, an indication that indicates the selected HARQ configuration ID and the PDU set. The WTRU may determine whether feedback is received (e.g., monitor for feedback) using the feedback parameters associated with the determined HARQ configuration ID (e.g., while in INACTIVE).

The term extended Reality (XR) may be used as an umbrella term for different types of immersive experiences, for example, including Virtual Reality (VR), Augmented Reality (AR) and Mixed Reality (MR) and the realities interpolated among them. Virtual Reality (VR) may be a rendered version of a delivered visual and audio scene. The rendering may be designed to mimic the visual (e.g., stereoscopic 3D) and audio sensory stimuli of the real world as naturally as possible to an observer or user as they move within the limits defined by the application. Augmented Reality (AR) may refer to when a user is provided with additional information or artificially generated items or content overlaid upon an environment (e.g., their current environment). Mixed Reality (MR) may be an advanced form of AR where some virtual elements are inserted into the physical scene with the intent to provide the illusion that these elements are part of the real scene. XR may include (e.g., all) real-and-virtual combined environments and human-machine interactions generated by computer technology and wearables.

The notion of immersion in the context of XR applications/services may refer to the sense of being surrounded by the virtual environment and/or providing the feeling of being physically and spatially located in the virtual environment. The levels of virtuality may range from partial sensory inputs to fully immersive multi-sensory inputs leading to a virtual reality practically indiscernible from actual reality.

XR devices may be associated with capabilities that offer various degrees of spatial tracking. XR devices may be equipped with various sensors to enable spatial tracking, for example, monocular/stereo/depth cameras, radio beacons, GPS, inertial sensors, etc. Spatial tracking may be performed at different levels, e.g., 3 Degrees of Freedom (DoF) (e.g., rotational motion along X, Y and Z axis), 6 DoF (e.g., rotational and/or translational motion along X, Y and Z axis). Spatial tracking may result in an interaction to experience some form of virtual content. The user may act in and/or interact with the components within extended reality. For example, the actions and/or interactions may involve movements, gestures, eye tracking, etc. Spatial tracking may enable immersive XR experience. For example, some form of head and/or motion tracking may ensure that the simulated visual and audio components from the user perspective are updated to be consistent with user's movements. Imprecise and/or delayed spatial tracking may lead to sensation of discomfort and/or motion sickness for the user.

A WTRU may correspond to a (e.g., any) XR device/node which may come in variety of form factors. A WTRU (e.g., XR WTRU) may include (e.g., but is not limited to) one or more of the following: Head Mounted Displays (HMD), optical see-through glasses and camera see-through HMDs for AR and MR, mobile devices with positional tracking and camera, wearables, etc. Different types of XR WTRU may be envisioned based on XR device functions (e.g., display, camera, sensors, sensor processing, wireless connectivity, XR/Media processing, power supply, etc.) to be provided by one or more devices, wearables, actuators, controllers and/or accessories. One or more device/nodes/WTRUs may be grouped into a collaborative XR group for supporting any of XR applications/services.

XR traffic may be considered. XR traffic may include different frames (e.g., I-frames, P-frames, B-frames, etc.). I-frames and P-frames may be mapped to a (e.g., one) flow. I-frames and P-frames may be mapped to different flows, for example, depending on the traffic model. For example, I-frames and P-frames may be slice-based. In this encoding scheme, a single video frame may be divided into N slices. Out of N, one slice may be an I slice and remaining N-1 slices may be P slices. For example, I-frames and P-frames may be GOP-based. In this encoding scheme, a (e.g., single) video frame may be either I frame or P frame.

I-frames may (e.g., generally) be larger in size as compared to P-frames.

XR Traffic may include protocol data unit (PDU) sets where one PDU-set consists of one or more PDUs.

Different PDU-sets may have different PDU-set delay bounds (PSDB) and/or different PDU-set error rate requirements (PSER).

XR experience may refer to the overall experience of the end user, for example, resulting from transmission and/or reception of the correct data to the correct end device in a reliable and timely manner.

XR action may refer to (e.g., any) one or more task(s) performed by the WTRU to enable the XR experience. XR action may refer to higher layer tasks and/or application-layer tasks and/or lower layer tasks in the protocol stack.

A data unit may refer to a frame, PDU, PDU-set, and/or group of frames/PDUs/PDU-sets/data bursts.

An event may, for example, result in a change in the current mode of operation/transmission/reception of data that may lead to (e.g., require) a change in resource allocation, statically, semi-statically or dynamically (e.g., change in resource grant allocation, change in periodicity of configured grant (CG and/or CG-SDT), application of offset to resource grant allocation, etc.). An event may be detected, for example, based on one or more of the following: the WTRU may receive an indication from an application of an expected delay, for example, due to jitter in the UL (e.g., as a result of processing delay from codec in AR glasses/VR headset); the WTRU may detect presence of jitter exceeding the allowed delay budget, for example, based on reception of the previous DL transmission; based on the timing of the arrival of data from the application being outside of the expected window of arrival (e.g., based on measurements by the WTRU), for example, which may lead the WTRU to alter/request for a change in the mode of resource grant allocation; etc.

A PDU set may include (e.g., be composed of) one or more PDUs carrying the payload of a (e.g., one) unit of information, for example, generated at the application level (e.g., a frame or video slice for XRM Services). the (e.g., all) PDUs in a PDU Set may be used (e.g., needed), for example, by the application/higher layer to use the corresponding unit of information. In examples, parts or all of the information unit may be recovered (e.g., by the application/higher layer), for example, if (e.g., when) some PDUs are missing.

A PDU set group or data burst may refer to a group of PDU sets generated and sent by the application/higher layer in a period of time (e.g., short period of time).

A PDU set integral handling indication (PSIHI) may be provided, received, and/or detected. A presence of PSIHI in a PDU set may indicate that (e.g., all) the PDUs of the PDU set are used (e.g., needed) to reconstruct the PDU set. The PDU set reconstruction may be skipped (e.g., refrained from being performed, may not be performed, may not be possible to be performed), for example, if one or more or a certain percentage of PDUs in the PDU set are lost and/or delayed beyond the PSDB. As such, delivering the remaining PDUs of the PDU set may not be useful.

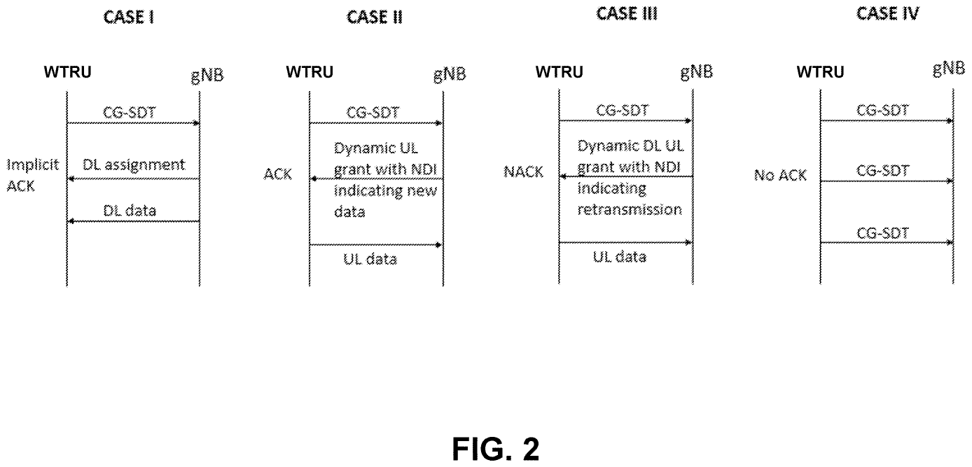

WTRUs (e.g., XR WTRUs) may operate in a connected state for extended periods of time for (e.g., frequent) UL and DL data transmissions. This may lead to constraints in the amount of power saving that can be achieved, for example, exacerbated by form factor restrictions for XR WTRUs. XR problems may include supporting high reliability, QoS maintenance, supporting large payload, maximizing power saving, etc. Less monitoring of DCI in an Inactive state may occur, for example, due to longer DRX off cycle times as compared to RRC Connected state. Enabling transmissions in inactive mode for XR may enable meeting XR QoS requirements while improving power savings. There may be no feedback mechanism for the WTRU to know that data was successfully received (e.g., as shown in FIG. 2 at Case IV), leading to PDU-set error rate requirements not being met, for example, if (e.g., when) a WTRU is configured with CG-SDT for operation in an INACTIVE state.

FIG. 2 illustrates example cases of transmissions between a WTRU and a base station for XR.

High Reliability Low Power XR operation may be supported.

Procedures described herein may occur in a semi-static or dynamic manner, once or multiple times, at the start and/or throughout the XR session/experience.

A WTRU may operate in a low-power state. A low power state may refer to a (e.g., any) state other than a connected state (e.g., RRC Connected state). In examples, low power state may refer to an inactive state (e.g., RRC Inactive state). In examples, low power state may refer to an idle state (e.g., RRC Idle state). In examples, low power state may refer to a state in between connected state and inactive state (e.g., between RRC Connected state and RRC Inactive state), for example, where a level of DCI monitoring of the WTRU is between preconfigured (e.g., the typical) levels for connected state (e.g., RRC Connected state) and inactive state (e.g., RRC Inactive state).

There may be different classes/types of XR WTRUs. The XR WTRU may be a regular WTRU and/or a reduced-capability WTRU and/or a WTRU designed to support high uplink and high downlink throughputs, low latency and high reliability (e.g., while maximizing its power saving margins). The WTRU may be a regular smartphone or a wearable pair of AR glasses. In examples, the WTRU may have a lower number of transmit antennas (e.g., 1 Tx antenna) and/or receive antennas (e.g., 2 Rx antennas) as compared to a regular WTRU (e.g., 2 Tx and/or 4 Rx antennas), for example, to extend its battery life and improve its thermal management (e.g., especially in the case of wearables).

There may be some requirements, preferences, or conditions associated with the XR WTRU belonging to a different class of WTRUs. In examples (e.g., as a result of being designed to support high uplink/downlink throughputs, low latency and high reliability while achieving good power saving gains), the WTRU may prioritize operation in a low power state and minimize the amount of time (e.g., measured in terms of length of time or number of cycles/slots) it spends in a connected state (e.g., RRC Connected state). In examples, the network may be made aware of the WTRU class or type through registration or initial capabilities exchange with the WTRU (e.g., via RRC signaling). The network may know that serving this class of WTRUs uses (e.g., requires) scheduling in a way to maximize to sleep or off cycle periods of the WTRU. As a result, the network may (e.g., also) prioritize operation in a low power state for the WTRU.

Transitioning in between states for the WTRU may be performed. For example, transitioning in between states for the WTRU may be WTRU-initiated). In examples, the WTRU may be aware of the predictable nature of the upcoming traffic (e.g., XR traffic) to be sent in the UL (e.g., from indications from the XR applications). As a result, the WTRU may send a request to the base station (e.g., gNB) to be transitioned into a low power state.

Transitioning in between states for the WTRU may be network-initiated. In examples, the network may receive indications from the WTRU (e.g., indications about the XR traffic characteristics of the traffic generated in the WTRU) such that the network may determine that the WTRU may operate in a low power state and still be able to successfully transmit its UL data. In examples, the network may (e.g., determine to) transition the WTRU to a low power state, for example, based on observation(s) of past XR traffic patterns sent in the UL. In examples, the network may (e.g., determine to) transition the WTRU to a low power state, for example, based on the upcoming downlink traffic (e.g., XR traffic). The network may receive statistics from the server (e.g., XR server) on the traffic characteristics or the network may determine that a low power operating mode may be appropriate, for example, based on observation(s) of past XR traffic pattern sent to the WTRU in the DL. In examples, the network may (e.g., determine to) transition the WTRU to a low power state based on joint knowledge of UL and DL traffic.

A RAN may have awareness of XR traffic characteristics, QoS metrics, and application later attributes. RAN awareness of the PDUs belonging to the same XR frame (e.g., which may include a (e.g., one) PDU-set) as well as the interrelation between multiple XR frames (PDU-sets) may result in more efficient handling of XR traffic and scheduling. In order to optimize XR traffic transmission/reception between the WTRU and network (e.g., from the RAN perspective), one or more of the following XR traffic characteristics, QoS metrics, and/or application layer attributes may aid handling of RAN awareness: PDU set level QoS metrics (e.g., delay budget, packet error rate, priority/importance); a PDU set boundary (e.g., the first/last packet in a PDU set); a PDU set size (e.g., payload sizes of all PDUs in PDU set, number of PDUs in a PDU set); periodicity; statistics characteristics of jitter, e.g., jitter range; intra/inter PDU sets dependency/synchronization; content of a PDU set (e.g., number of frames by type, e.g., number of I-frames/P-frames/B-frames); etc.

Size of data (e.g., size of frame and/or PDU and/or PDU-set and/or group of PDU-sets) may be determined. A PDU-set may include one or more PDUs. A PDU-set may include PDUs corresponding to (e.g., only) one type of frame (e.g., I-frame) or PDUs corresponding to different types of frames (e.g., I-frames, P-frames, B-frames, etc.). The size of the PDU-set may be variable from one PDU-set to another.

The WTRU may receive one or more indication(s) (e.g., from the application/higher layers), for example, indicating (e.g., about) the size of the PDU-set. In examples, the indication may be received (e.g., come) in the packet header of the first packet/PDU in the PDU-set. The WTRU may receive the indication(s) (e.g., from the application) that the WTRU may use to infer the size of the PDU-set. In examples, the WTRU may receive the indication(s) about the first and the last packet in the PDU-set, for example, which may be indicated in the headers of the first and the last packet.

The WTRU may receive size information, for example, on a (e.g., more) granular level. In examples, the WTRU may receive the indication(s) from the application indicating (e.g., about) the typical size of different frames (e.g., I-frame, P-frame, B-frame). The first or last packet in the PDU-set may include information indicating its type (e.g., corresponding to an I-frame or P-frame) and that it is the first/last packet of the PDU-set. The WTRU may estimate the size of the PDU-set, for example, based on this information.

The WTRU may receive an indication linking the data flow to the frame type (e.g., only once) at the start of the session, for example, in an encoding scheme where different types of frames are encoded into different traffic streams (e.g., GOP-based whereby a single video frame is either an I-frame or P-frame).

In examples, the indication from the application to the WTRU may be a bit-type, for example, where “0” may correspond to a data flow with I-frames and “1” may corresponding to a data flow with P-frames.

The WTRU may receive information indicating (e.g., about) the size of the PDU-set on a PDU-set basis and/or on a per-flow basis (e.g., in the GOP-based encoding scheme). This exchange may happen at the start of a session (e.g., the XR session). The WTRU may receive updates (e.g., regular updates) throughout the session (e.g., XR session), for example, periodically or (e.g., only) if there is a change in the information (e.g., change in size of PDU-set).

The WTRU may receive information (e.g., from the application/higher layers) indicating (e.g., on) multiple PDU-sets (e.g., granularity of group of PDU-sets). The application may group PDU-sets based on similarities between individual PDU-sets (e.g., same size, type, etc.).

Latency of data (e.g., latency of frame and/or PDU and/or PDU-set and/or group of PDU-sets) may be determined.

Different latency requirements may be associated with different types of frames. The PDU-set Delay Budget (PSDB) may be different from one PDU-set to another PDU-set and from one group of PDU-sets to another group of PDU-sets, for example, as a result of the possible variance in per-frame PDB requirements. There may be an indication (e.g., implicit or explicit indication) of delay budgets per unit of data. In examples, the WTRU may (e.g., explicitly) receive (e.g., in the header of the first packet of each PDU-set) the PSDB of the PDU-set. In examples, the WTRU may receive per-frame delay budget requirements from the application, for example, such that (e.g., on reception of a PDU-set containing only I-frames) the WTRU can determine the PSDB of the PDU-set. In examples, the WTRU may receive the PSDB of a (e.g., one) PDU-set and may assume that the PSDB of the following PDU-sets is the same (e.g., unless otherwise indicated).

The WTRU may receive (e.g., from the application) default values for the latency budget for different units of data (e.g., frame basis and/or PDU basis and/or PDU-set basis and/or group of PDU-set basis), for example, such that in the absence of (e.g., any) indication (e.g., explicit or implicit indication) from the application, the WTRU may use the default values.

Importance of data (e.g., importance of frame and/or PDU and/or PDU-set and/or group of PDU-sets) may be determined and/or indicated.

Importance of data may be indicated to the WTRU, for example, from the application on different data-unit granularities (e.g., importance on a per-frame basis and/or per-PDU basis and/or per-PDU-set basis and/or per-group of PDU-sets basis, etc.).

An indication of importance may be indicated for a (e.g., every) data unit. An indication of importance may be indicated for a first data unit and an indication may be refrained from being sent for following (e.g., subsequent) data units (e.g., no indication is sent for the following data units), for example, unless (e.g., until) there is a change in the importance. An indication of importance may be a bit-wise binary indication or a flag indicating if the data is important enough to necessitate a special treatment. In examples, the WTRU (e.g., XR application in the WTRU) may flag a group of PDU-sets as important such that the WTRU may determine that transitioning to the connected state (e.g., RRC Connected state) may be performed (e.g., be required) to have better access to resource grants for a fast and reliable (e.g., lower MCS) transmission of the group of PDU-sets.

Indication of importance may be indicated through a table mapping different QoS levels in the legacy QoS framework to different importance levels. In examples, QoS levels (e.g., four most important QoS levels) from the QoS framework may be flagged as important such that the WTRU may determine that (e.g., any) data mapped to radio bearers with the corresponding QOS flows from the (e.g., four most important) QoS levels may (e.g., need to) be sent from the connected state (e.g., RRC Connected state). Data (e.g., any data) mapped to radio bearers with QoS flows from the remaining QoS levels may be sent in low power states.

Indication of importance may override QoS levels from the traditional QoS framework in some cases (e.g., if the data in the buffer is about to expire).

Information may be transmitted, for example, to enable high reliability low power data transmissions/receptions. The WTRU may send to network the information (e.g., possibly associated with XR actions), for example, based on one or more of the following triggering events: during connectivity/session establishment and/or (re)configuration (e.g., during RRC connection, PDU session, application session establishment and/or (re)configuration); if (e.g., when) changing/updating XR actions (e.g., if/when new XR actions and/or releasing XR actions); if (e.g., when) receiving higher layer/application information (e.g., if/when receiving an indication (e.g., from application function hosted in WTRU or in network) indicating change in XR actions, forwarding configurations, etc.); if (e.g., when) detecting change in measurements and movements (e.g., if/when the RSRP, RSRQ, RSSI measurements of the signals, channels, radio links, carriers, etc., possibly associated with the one or more XR actions, are above/below threshold values, or if/when pose/positioning measurements (e.g., location information, pose in 6DoF) are above/below corresponding pose threshold values); if (e.g., when) detecting change in time/timing attributes (e.g., the WTRU may send information periodically or when a timer associated with sending of assistance information is set and/or expires); etc.

The WTRU may send higher/application-layer information to a NW or gNB. The WTRU may send assistance information (e.g., on higher/application-layer information) to NW or gNB. This information may include (e.g., any) parameters from the higher/application layers that may assist the NW/gNB in its scheduling task for the WTRU, for example, such as one or more of the following: information about the traffic (e.g., information like packet size or expected arrival of PDUs or a group/cluster/burst of PDUs); expected periodicity of traffic; average expected jitter of traffic; dependency information indicating the dependency between one or more PDUs within a PDU set and/or one or more PDU sets within a PDU set group/data burst (e.g., the one or more PDUs/PDU sets which may be dependent on a first/root PDU/PDU set may carry the identifier/ID of the first/root PDU/PDU set, in the PDU header); one or multiple threshold(s) associated to the XR experience/XR application that may use (e.g., require) the triggering of a different resource grant allocation/configuration WTRU; importance of payload in the WTRU buffer to be sent in the uplink; reliability to send data in the uplink; any of the parameters described herein (e.g., jitter, data size, periodicity, reliability with which to transmit data, dependency info within PDU set and/or across multiple PDU sets etc.) related to the data that the WTRU sends in the uplink may be transmitted by the WTRU semi-statically or dynamically (e.g., on a per-frame basis and/or per-PDU basis and/or per-PDU-set basis and/or per-group of PDU-sets basis, and/or per data burst basis, and/or per group of data burst basis, etc.) The WTRU may send assistance information on higher/application-layer information to NW/gNB, such as, for example, information associated with reliability to send data in the uplink. In examples, the application in the WTRU may have marked (e.g., explicitly marked) the data with different reliability levels. The WTRU may convey (e.g., directly) convey the information to the gNB. In examples, the WTRU may determine the reliability of the data to be sent in the uplink implicitly and send the indication to the gNB. The WTRU may determine that the first PDU in a PDU-set or the first PDU-set in a data burst or the first data burst in a group of data bursts may (e.g., need to) be transmitted with higher reliability. The WTRU may convey this information to the gNB semi-statically (e.g., via RRC signaling) and/or dynamically (e.g., on a per-frame basis and/or per-PDU basis and/or per-PDU-set basis and/or per-group of PDU-sets basis, and/or per data burst basis, and/or per group of data burst basis). In examples, the WTRU may determine a certain type of data may (e.g., need to) be sent with high reliability compared to other types of data. For example, data corresponding to a type of PDU-Set (e.g., PDU-Set Type 1) may (e.g., need to) be sent with higher reliability than data corresponding to another type of PDU-Set (e.g., PDU-Set Type 2). Data corresponding to a type of frame (e.g., I-frame) may (e.g., need to) be sent with higher reliability than data corresponding to another type of frame (e.g., P/B-frame). In examples, the WTRU may determine that a second PDU-set in a PDU set group/Data burst may be dependent on the first PDU set in the group or burst, e.g., based on the markings in the PDU set headers. In this case, the reliability value associated with the first PDU set may apply to the second PDU set during data transmissions. The dependency information (e.g., across PDU sets) and the associated reliability values may be used for determining if any of the second/subsequent PDU sets may be dropped or discarded by the WTRU, for example, based on whether the reliability requirement is met for the first dependent PDU set during UL transmission. The WTRU may drop a second PDU set dependent on a first PDU set (e.g., for realizing power savings), for example, if (e.g., when) the reliability requirement for the first PDU set is not met during UL transmission.

The WTRU may send other requests or information to the NW/gNB.

The WTRU may send a request for a UL grant (e.g., CG-SDT, RA-SDT, DG grant, CG grant). The WTRU may use CG-SDT (e.g., the allocated CG-SDT) grant to send some data in the UL. The WTRU may send a request for an UL grant to the NW (e.g., to fit in the remaining data), for example, if (e.g., in the event) the WTRU has (e.g., some) remaining data to send. The WTRU may send an SR/BSR to the NW, for example, if (e.g., when) the WTRU has a payload (e.g., more payload) to transmit that can be accommodated with its current configurations (e.g., CG-SDT).

The WTRU may send a request to transition to the connected state (e.g., RRC Connected state). The request to transition to the connected state (e.g., RRC Connected state) may include one or more of the following: a simple request to transition to the connected state (e.g., RRC Connected state); a request to transition to the connected state (e.g., RRC Connected state) accompanied by additional information (e.g., duration to remain in RRC Connected state) based on knowledge of XR traffic from the application; etc.

The WTRU may send a request to remain in the connected state (e.g., RRC Connected state). The request to remain in the connected state (e.g., RRC Connected state) may include one or more of the following: a simple request to remain in the connected state (e.g., RRC Connected state); a request to remain in the connected state (e.g., RRC Connected state) accompanied by additional information (e.g., duration to remain in RRC Connected state) based on knowledge of XR traffic from the application; etc.

The WTRU may send a request to transition to a low power state (e.g., RRC Inactive state). The request to transition to a low power state may include one or more of the following: a simple request to transition to a low power state (e.g., RRC Inactive state); a request to transition to a low power state accompanied by additional information (e.g., duration to remain in low power state) based on knowledge of XR traffic from the application; etc.

The WTRU may send a request to remain in a low power state (e.g., RRC Inactive state). The request to remain in a low power state may include one or more of the following: a simple request to remain in a low power state (e.g., RRC Inactive state); a request to remain in a low power state accompanied by additional information (e.g., duration to remain in low power state) based on knowledge of XR traffic from the application; etc.

The WTRU may send indication(s) to the network indicating (e.g., on) the assessment result, for example, from determination of the data that may be sent in a low power state. In examples, (e.g., instead of sending a request to transition/remain in an RRC state) the WTRU may send the results from its assessment based on traffic information from the XR application, for example, leaving it to the NW to determine whether the WTRU should be transitioned to a different state (e.g., an RRC state different to its current RRC state). The WTRU may share (e.g., have shared) its capabilities information in an (e.g., initial) exchange with the NW. The NW may (e.g., already) be aware that operation in a low-power state may (e.g., need to) be prioritized for this class/type of WTRU, for example, if (e.g., in the event) the WTRU is a different class or type WTRU. In examples, the WTRU may send an indication (e.g., UCI, BSR, other MAC CE, other signaling) to the NW indicating (e.g., on) the result of the assessment, for example, whereby the WTRU may indicate information about the traffic in its buffer (e.g., number of frames, frame type, frame size, number of transmission cycles/slots/occasions that the WTRU anticipates it will take to transmit the payload in the UL, etc.)

The WTRU may send indication(s) to the network on the assessment result from determination of the reliability with which to send data in the UL. The indication may be semi-static (e.g., statistics/information sent in one shot (e.g., during RRC configuration and/or reconfiguration)). The indication may be dynamic (e.g., per data which may be on a per-frame basis and/or per-PDU basis and/or per-PDU-set basis and/or per-group of PDU-sets basis, and/or per data burst basis, and/or per group of data burst basis, etc.).

The WTRU may send indication(s) to the network on the process (e.g., procedure/method) for sending high-reliability data (e.g., whether the WTRU is to duplicate UL payload prior to sending or WTRU to request for ACK/NACK).

The WTRU may send data to the network flagged with a high reliability indicator.

The WTRU may send indication(s) from an XR application. In examples, (e.g., instead of sending the assessment results) the WTRU may send the (e.g., raw) information on the traffic characteristics sent by the application, for example, leaving it to the NW to assess whether/if (e.g., when) a state transition (e.g., an RRC state transition) should be performed (e.g., required/warranted/preferred to be performed).

The WTRU may send a confirmation of receipt of a grant. The WTRU may send a confirmation of receipt of the grant to the NW, for example, in response to a (e.g., any) grant from the NW (e.g., CG-SDT or DG).

The WTRU may send data to the NW. In examples, the WTRU may send the data stream with the P-frames in a low power state (e.g., RRC Inactive state).

Information may be received, for example, to enable high reliability low power data transmissions/receptions. In examples, the WTRU may receive indications from the application/higher layers, such as, for example, one or more of the following parameters: information about the traffic (e.g., information like packet size or expected arrival of PDUs or a group/cluster/burst of PDUs); expected periodicity of traffic; average expected jitter of traffic; one or multiple threshold(s) associated to the XR experience/XR application that may use (e.g., require) the triggering of a different resource grant allocation/configuration WTRU; importance of payload in the WTRU buffer to be sent in the uplink; reliability to send data in the uplink (e.g., the application in the WTRU may have explicitly marked the data with different reliability levels); any of the parameters described herein (e.g., jitter, data size, periodicity, reliability with which to transmit data, dependency between PDUs etc.) related to the data that the WTRU sends in the uplink may be transmitted by the WTRU (e.g., on a per-frame basis and/or per-PDU basis and/or per-PDU-set basis and/or per-group of PDU-sets basis, and/or per data burst basis, and/or per group of data burst basis, etc.); etc.

In examples, the WTRU may receive one or more thresholds from the gNB or network, for example, corresponding to the reliability of the data. The threshold(s) may (e.g., only) correspond to the reliability aspects of the data to be sent in the UL, for example, irrespective of the state (e.g., RRC state) that the WTRU may be operating in. The threshold may (e.g., specifically) correspond to reliability aspects of the data to be sent in the UL when the WTRU is in a low power state (e.g., RRC Inactive state).

High reliability data transmissions/receptions may be enabled while operating in low-power state.

A WTRU may determine the data that may be sent with high reliability in low-power state.

The WTRU may determine the volume (e.g., total) volume and timing of data that can be sent in an inactive state with high reliability, for example, based on one or more of the following: a number of I-frame v/s P-frame; an associated per-frame delay budget; an importance of data unit; configuration information from the NW/gNB; a data QoS metrics, e.g., PDU set level QoS metrics (e.g., delay budget, packet error rate, priority/importance); a data boundary, e.g., PDU set boundary (e.g., the first/last packet in a PDU set); data size, e.g., PDU set size (e.g., payload sizes of all PDUs in PDU set, number of PDUs in a PDU set); data periodicity, e.g., periodicity of PDU set or data burst; statistics characteristics of jitter, e.g., jitter range; intra/inter PDU sets dependency and/or intra/inter data burst dependency; synchronization (e.g., between multiple flows); content of PDU set (e.g., number of frames by type, e.g., number of I-frames/P-frames/B-frames); explicit indication from XR application/higher layers flagging data as high reliability data; thresholds from gNB; etc.

In examples, the WTRU may determine to remain in a higher power state (e.g., RRC Connected state) to send higher reliability data (e.g., with reliability above a preconfigured threshold). The WTRU may remain in a connected state (e.g., until transmission of data is complete), for example, if the reliability of data to be sent in uplink is greater than a threshold.

In examples, the WTRU may determine to transition to a higher power state (e.g., RRC Connected state) from a lower power state (e.g., RRC Inactive state) to send higher reliability data (e.g., with reliability above a preconfigured threshold).

In examples, the WTRU may receive configuration information from the NW or gNB. The configuration information may include data volume thresholds such that the WTRU is configured/indicated by the NW that it may (e.g., be possible to) transmit a UL payload volume lower than that data volume threshold while remaining in a low-power state (e.g., transmission in RRC Inactive state using CG-SDT resources). The WTRU may assess the volume of the data received from the application (e.g., number/types of frames, frame size, etc.) against the data volume threshold from the NW, for example, while in a low power state (e.g., RRC inactive state), e.g., if (e.g., when) the WTRU receives data in its buffer (e.g., from the application). The data volume threshold from the gNB may correspond to the UL payload volume within one or multiple CG-SDT slots/transmission cycles.

the WTRU may use the CG-SDT grants to send the UL data, for example, while remaining in an Inactive state, e.g., if the volume of data in its buffer is less than the data volume threshold.

In examples, the WTRU may determine that the volume of data of the smaller frames (e.g., P-frames) is below the data volume threshold from the gNB, for example, such that the WTRU may (e.g., may be able to, may only) send the smaller frames (e.g., P-frames) while in a low power state (e.g., Inactive state).

In examples, the WTRU may determine that segmenting/splitting the UL data in its buffer into multiple CG-SDT slots/transmissions cycles satisfies the threshold requirement for low-power state transmission. The WTRU may split its data according to the one or multiple data volume thresholds. The WTRU may (e.g., based on splitting its data according to the one or multiple data volume thresholds) send it across one or multiple CG-SDT slots/transmission cycles.

In examples, the WTRU may send an indication to the NW of a higher incoming volume of data for the next x number of cycles/transmission slots. In response, the NW may increase the size of the UL grant in the x number of CG-SDT cycle(s)/transmission slot(s) and/or the NW may increase the number of UL grant in the x number of CG-SDT cycle(s)/transmission slot(s) (e.g., from one UL grant in one cycle/transmission slot to two UL grants in one cycle/transmission slot). In the latter scenario, the multiple (e.g., two) UL grants within one cycle/transmission slot may be consecutive or spaced out from each other (e.g., with slots in between).

The data volume threshold (e.g., received from the gNB) may be on a per-radio bearer basis or it may be a total data volume threshold (e.g., total data volume threshold based on the aggregation of the data in all the radio bearers at the WTRU and/or the total data volume threshold based on the aggregation of the data in all the radio bearers where a low-power state resource configuration (e.g., CG-SDT) is enabled).

In examples, the WTRU may receive configuration information (e.g., from the NW/gNB) including delay budget thresholds, for example, such that the WTRU has been indicated by the NW that it may (e.g., be possible to) transmit UL payload data whose delay budget is within the threshold bounds while remaining in a low-power state (e.g., transmission in RRC Inactive state using CG-SDT resources). The WTRU may assess the delay budget of the data received from the application (e.g., PDB, PSDB etc.) against the delay budget threshold from the NW, for example, while in a low power state (e.g., RRC inactive state), e.g., if (e.g., when) the WTRU receives data in its buffer (e.g., from the application).

In examples, the WTRU may receive (e.g., from the application) the PSDB of the PDU-sets in its buffer, e.g., such that the WTRU may assess whether (e.g., it may be able) to transmit the PDU-sets within their PSDB requirements while remaining and/or transitioning to a low power state (e.g., RRC Inactive state) or whether it is (e.g., needs) to remain/transition to the connected state (e.g., RRC Connected state) to successfully transmit the PDU-sets in its buffer within their PSDB requirements.

In examples, the WTRU may be aware that in the absence of any other indication (e.g., explicit or implicit indication), I-frames may be more important than P-frames. As such, the WTRU may remain in the connected state (e.g., RRC connected state) or transition to the connected state (e.g., RRC connected state) to send the I-frames, for example, because (e.g., since) the WTRU may determine that it may have access to larger and/or more frequent UL grants while in the connected state (e.g., RRC Connected state) to meet the PSDB requirements for the I-frames. The WTRU may subsequently transition to a low power state (e.g., RRC Inactive state) to transmit the remaining P-frames.

In an exemplary solution, the WTRU may receive configuration information from the NW or gNB. The configuration information may include quality, priority metrics, and/or thresholds, for example, such that the WTRU has been indicated by the NW (e.g., that it may be possible) to transmit UL payload data whose data importance exceeds the quality/priority metrics/thresholds while remaining in a low-power state (e.g., transmission in RRC Inactive state using CG-SDT resources). The WTRU may assess the importance/priority level/reliability with which it needs to send the data received from the application in the UL to the gNB against the quality/priority metrics/threshold from the NW, for example, while in a low power state (e.g., RRC inactive state) (e.g., if/when the WTRU receives data in its buffer (e.g., from the application).

In examples, the WTRU may receive an indication (e.g., flag) indicating important data and/or priority level and/or high reliability data corresponding to the importance of data and/or the reliability with which the data needs to be transmitted in the UL. The (e.g., each) data unit (e.g., PDU-set) may be sent to the WTRU from the application with an importance/priority level. The WTRU may assess the importance/priority level of the PDU-set in its buffer (e.g., against the threshold from the NW), for example, such that if the importance/priority level of the PDU-set in its buffer exceeds the threshold, the WTRU may be able to transmit the PDU-set while remaining in a low power state (e.g., RRC Inactive state).

In examples, a (e.g., each) data unit (e.g., group of PDU-sets) may be sent to the WTRU from the application with an importance/priority level. The WTRU may assess the importance/priority level of the group of PDU-sets in its buffer against the threshold from the NW. The WTRU may determine that transitioning to the connected (e.g., RRC Connected state) may provide it with more resources (e.g., larger and more frequent grants) to successfully transmit the group of PDU-sets, for example, if the importance/priority level of the group of PDU-sets in its buffer exceeds the threshold.

A WTRU may determine whether to indicate (e.g., flag) data for high reliability if (e.g., when) transmitting the data in the UL, for example, based on indications from the XR application and importance/reliability thresholds received from the gNB/NW.

The WTRU may transmit an indication (e.g., flag) along with the data to indicate a request for ACK/NACK feedback, for example, if the importance of UL payload is greater than a threshold from the gNB. The WTRU may add the indication (e.g., flag) in the first PDU of a PDU-set or the first PDU-set in a data burst. The WTRU may send the data without a flag, for example, if the importance of the UL payload is less than a threshold from the gNB.

In examples, the indication (e.g., flag) may be added to the data in the SDAP layer in the WTRU. The indication (e.g., flag) may be added in (e.g., any) a different (e.g., other) layer in the WTRU (e.g., application).

A WTRU may determine the number a of transmissions in a low power state (e.g., a CG-SDT transmissions in RRC Inactive state) after which it will use (e.g., require) feedback from the network based, for example, based on the important of the data being transmitted. The WTRU may send to gNB or NW a request for ACK/NACK feedback for the previous a number of CG-SDT transmissions, for example, if (e.g., after sending of a CG-SDT transmissions) the WTRU does not receive (e.g., any) ACK/NACK feedback from the gNB/NW. This request may be a standalone request for ACK/NACK feedback or it may be sent as part of a (e.g., any) UL transmission from the WTRU to the gNB or NW (e.g., SR/BSR/upcoming CG-SDT transmission/upcoming UL transmission, etc.).

A WTRU may (e.g., determine to) duplicate the high reliability data if (e.g., when) transmitting the data in the UL, for example, based on indication(s) (e.g., from the XR application) and importance/reliability thresholds (e.g., received from the gNB or NW). The lower layers (e.g., PDCP) may be instructed to duplicate the data, for example, following reception of the data from the higher/application layers.

The WTRU may duplicate the data/payload, for example, if the importance of the UL payload is greater than a threshold from the gNB. The WTRU may duplicate the payload/data entirely or partially, for example, depending on the indication(s) (e.g., from the application). The first PDU in a PDU-set and/or first PDU-set in a data burst may be the (e.g., only) part of the data with importance above the threshold to require packet/data duplication. The WTRU may send the data without any duplication, for example, if the importance of UL payload is less than a threshold from the gNB.

Duplication of data may be on a per-frame basis, per-PDU basis, per-PDU-set basis, per-group of PDU-sets basis, per data burst basis, per group of data burst basis, and/or the like.

The WTRU may determine to send high reliability data transmissions while operating in low-power state.

A WTRU may determine which process to apply if (e.g., when) sending high reliability data in a low power state. For example, a WTRU may receive one or more thresholds from the gNB which may correspond to different treatment of the high reliability data and the WTRU may be configured to select a treatment depending on indications from the XR application on the importance or reliability of the data to be sent in the UL.

The WTRU may (e.g., if the importance of the UL payload is greater than a threshold and PDB of UL payload is greater than a delay threshold) select one treatment, e.g., request for ACK/NACK feedback from the gNB or NW after sending a CG-SDT transmissions, for example, if the WTRU does not receive any ACK/NACK feedback from the gNB/NW for the a number of CG-SDT transmissions.

The WTRU may (e.g., if the importance of the UL payload is greater than a threshold and PDB of UL payload is less than a delay threshold) select a more proactive approach (e.g., duplicating the data), for example, due to the more stringent delay requirements.

Enhancements to support reliable transmissions may be performed proactively. A WTRU may be in an inactive state (e.g., RRC Inactive State). A WTRU may receive configuration information (e.g., from a base station) for operating in an inactive state (e.g., CG-SDT resources and importance thresholds corresponding to PDU-sets or groups of PDU-sets). The WTRU may receive one or more PDU-set(s) to send in UL. The WTRU may determine an importance of (e.g., associated with) a payload (e.g., on a PDU-set or group of PDU-sets basis). The WTRU may determine the importance of the payload, for example, based on a received indication. The WTRU may receive an indication (e.g., from an application) indicating an importance of a payload (e.g., on a PDU-set or group of PDU-sets basis). The WTRU may determine whether to indicate (e.g., flag) data for high reliability, for example, based on an indication from the application and the thresholds indicated by the base station. For example, if the importance of the UL payload is greater than the threshold, the WTRU may send data with an indication (e.g., flag) indicating a request for feedback (e.g., in the header of a first PDU or PDU-set or header of a fist PDU-set in a group of PDU-sets, e.g., data burst). The WTRU may send the data without an indication (e.g., flag), for example, if the importance of the UL payload is less than the threshold.

Enhancements to support reliable transmissions may be performed reactively. A WTRU may be in an inactive state (e.g., RRC Inactive State). The WTRU may receive configuration information (e.g., from a base station) for operating in an inactive state (e.g., CG-SDT resources). The WTRU may receive one or more PDU-set(s) to send in UL. The WTRU may receive an indication (e.g., from an application) indicating an importance associated with the PDU-set(s). The WTRU may send the PDU-set(s) in UL. The WTRU may fit the PDU-set(s) in a CG-SDT UL grant. The WTRU may perform segmentation of the PDU-set(s) to fit into multiple CG-SDT slots/transmission cycles. The WTRU may determine a number of CG-SDT transmissions (e.g., x number of transmissions), for example, after which it may request (e.g., need) feedback from the NW (e.g., based on the importance of the PDU-set(s)/data burst). The WTRU may send to the base station a request for an ACK for x number of CG-SDT transmissions, for example, if the WTRU does not receive feedback from the base station (e.g., after x CG-SDT transmissions).

Enhancements to support reliable transmissions associated with proactive data duplication may be performed. A WTRU may be in an inactive state (e.g., RRC Inactive State). The WTRU may receive configuration information (e.g., from a base station) for operating in an inactive state (e.g., CG-SDT resources, an importance threshold(s) corresponding to PDU-sets or groups of PDU-sets). The WTRU may receive one or more PDU-set(s) to send in the uplink. The WTRU may receive an indication (e.g., from an application) associated with the importance of the payload (e.g., on a PDU-set or group of PDU-sets basis). The WTRU may determine whether to duplicate data with high reliability (e.g., based on an indication from the application and the base station threshold). The WTRU may duplicate the threshold, for example, if the importance of the UL payload is greater than the threshold. The WTRU may send the data without duplication, for example, if the importance of the UL payload is less than the threshold.

Enhancements to support reliable transmissions may be performed associated with a high reliability. A WTRU may be in an inactive state (e.g., RRC Inactive State). The WTRU may receive configuration information (e.g., from a base station) for operating in an inactive state (e.g., CG-SDT resources, importance thresholds corresponding to PDU-sets or groups of PDU-sets). The WTRU may receive one or more PDU-set(s) to send in the UL. The WTRU may receive an indication (e.g., from the application) associated with the importance of the payload (e.g., on a PDU-set or group of PDU-sets basis). The WTRU may determine whether to duplicate data with high reliability or use ACK/NACK feedback, for example, based on reliability. The WTRU may use ACK/NACK feedback to send the data, for example, if the importance of the UL payload is greater than the threshold and the PDB of the UL payload is greater than the delay threshold. The WTRU may duplicate the data in the payload, for example, if the importance of the UL payload is greater than the threshold and the PDB of the UL payload is less than the delay threshold.

Data (e.g., important data) may be indicated (e.g., flagged).

The WTRU may determine whether to indicate (e.g., flag) data for high reliability, for example, based on an indication from application and/or configuration information from network (e.g., if PSI >threshold).

The WTRU (e.g., higher/application layer in the WTRU) may indicate (e.g., flag) the data as high importance, for example, in which case the (e.g., lower layers in the) WTRU may receive data indicated (e.g., flagged) as high importance.

The WTRU (e.g., SDAP layer in the WTRU) may receive an indication from the (e.g., higher/application layer in the) WTRU that the data is of high importance, for example, in which case the WTRU (e.g., SDAP layer in the WTRU) may add an indication (e.g., flag) to the high PSI data (e.g., in the SDAP header).

In examples, a high importance marking (e.g., flag) may be added to the first PDU of a high PSI PDU set.

Data indicated (e.g., flagged) as important (e.g., presence of flag) may use (e.g., require) feedback (e.g., even if transmitted in inactive state via CG-SDT grants). As such, the network may be aware (e.g., may know) that the WTRU is expecting feedback for the data, for example, based on reception of important data from the WTRU.

The WTRU may determine to duplicate data.

In examples, the WTRU may (e.g., selectively) duplicate the data in its buffers (e.g., PDCP buffer). While duplication for cases like dual connectivity and carrier aggregation may be supported (e.g., by legacy systems), the duplication in those cases may be intended for different nodes (e.g., different MAC entities). In this case (e.g., as described herein), there may be an (e.g., one) entity (e.g., MAC entity) and the duplication may be based on the PDU Set Importance (PSI) and/or PDU Set Error Rate (PSER). The WTRU may perform duplication of the data in its buffer, for example, for a PDU set of high importance (e.g., PSI>a threshold, which the WTRU may have received from the network as part of initial configuration information). The WTRU may perform duplication of the data in its buffer (e.g., in PDCP and/or RLC buffer), for example, if PSI≥5.

In examples, the WTRU may receive configuration information associated with (e.g., be configured to) enable/activate (e.g., autonomously enable/activate) duplication based on PSI. The WTRU may perform duplication, for example, for a (e.g., any) PDU set for which PSI exceeds a threshold.

In examples, the WTRU may receive an indication or request to activate duplication from the network.

The packet (e.g., PDCP PDU) may be transmitted to an RLC entity and the RLC entity may then transmit it to the MAC entity, for example, if (e.g., in the case where) PDCP duplication is determined to be not activated or enabled or the threshold for activating duplication is not met or exceeded.

The packet (e.g., PDCP PDU) may be transmitted to multiple (e.g., two) RLC entities (e.g., Primary RLC entity and Secondary RLC entity), for example, if (e.g., in the case where) PDCP duplication is determined to be activated enabled or the threshold for activating duplication is met or exceeded.

Adapted feedback (e.g., HARQ) configuration information may be provided and/or enabled.

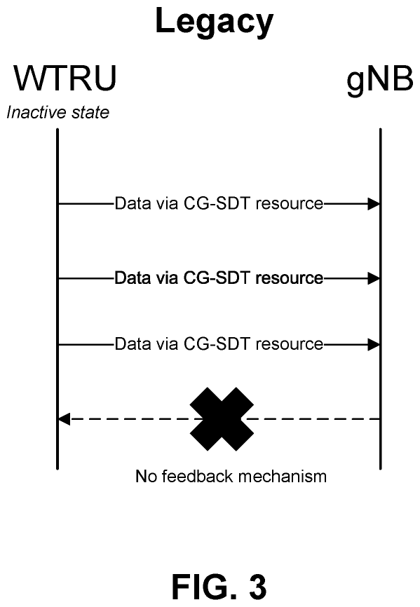

A WTRU (e.g., in INACTIVE state) may receive configuration information indicating (e.g., be configured with) CG-SDT (e.g., CG-SDT resources associated with inactive state) for it to make UL transmissions, for example, while staying in inactive state (e.g., operating while in inactive state). This may be useful for XR, for example, because with the high bit rates and low latency requirements for XR traffic, it may be difficult or hard to achieve power saving. In inactive state in a legacy system, the reliability that may be used (e.g., required) for the traffic may not be achieved (e.g., possible to be achieved) by using the legacy CG-SDT mechanism. As illustrated in FIG. 3, the WTRU may refrain from receiving feedback (e.g., may not receive feedback, may not be possible for the WTRU to receive feedback) on data transmitted in inactive state via CG-SDT grants.

FIG. 3 illustrates an example legacy system not receiving feedback from a gNB.

High reliability PDU set transmissions while operating in a low power state may be supported.

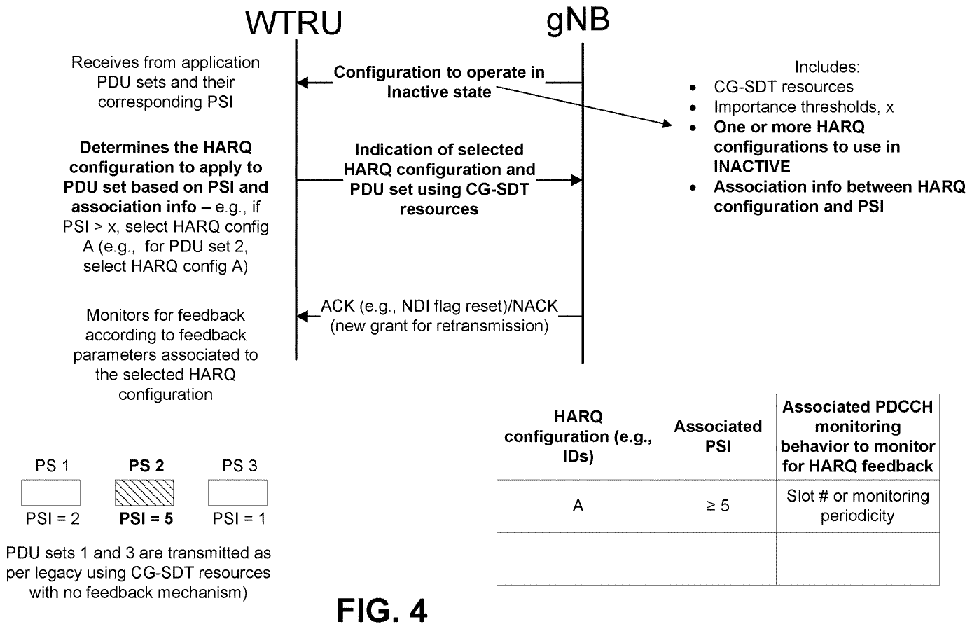

FIG. 4 illustrates an example HARQ feedback adaptation.

As shown in FIG. 4, the WTRU may receive (e.g., from the network) configuration information indicating to operate in INACTIVE state (e.g., associated with operating in inactive state). The configuration information may include one or more of the following: CG-SDT resources (e.g., associated with inactive state); importance thresholds, x; one or more HARQ configurations to use in a low power state (e.g., RRC INACTIVE state); association information between HARQ configuration and PDU set importance (PSI) (e.g., PSI threshold or PSI range), e.g., a table mapping different HARQ configurations (e.g., via a HARQ configuration ID for each configuration) with different PSI; etc.

The WTRU may receive from the application in the WTRU, data, e.g., PDU sets and their corresponding PSI (e.g., the WTRU may determine a PDU set and a value associated with the PDU set (e.g., associated PSI).

The WTRU may select a (e.g., one of the) preconfigured HARQ configuration (e.g., while operating in the inactive state), for example, based on the PSI and associated information (e.g., as shown in FIG. 4). The WTRU may send an indication (e.g., to the base state) that indicates the selected HARQ configuration and/or the determined PDU set (e.g., as shown in FIG. 4). The WTRU may select HARQ configuration A, for example, if PSI of PDU set 2≥5. HARQ configuration A may have an associated monitoring behavior (e.g., monitoring parameter or feedback parameter), e.g., the periodicity at which the WTRU would be monitoring the feedback, or the slot number it may receive (e.g., expect to receive) the feedback for PDU set 2. For example, a higher PSI may be associated with a higher periodicity of monitoring for the feedback (e.g., because the WTRU may not want to miss the feedback).

The WTRU may monitor for the feedback (e.g., determine whether feedback is received) according to the configuration it selected (e.g., according to the feedback parameter associated with the selected HARQ configuration).

The monitoring behavior of the WTRU may be different (e.g., different to legacy, for example, because in legacy the WTRU may typically only monitor for paging in INACTIVE state).

The WTRU may determine the HARQ configuration to apply to data, for example, based on PDU set attributes.

The WTRU (e.g., MAC entity in WTRU) may receive configuration information indicating (e.g., be configured with) a (e.g., one or more) HARQ configuration from one or more HARQ entities to use in INACTIVE state. A (e.g., each) HARQ configuration may be associated with one or more of the following parameters which the WTRU (e.g., MAC entity in the WTRU) may use to determine the HARQ configuration to apply to the data: different parameters, for example, a different data indicator (e.g., new data indicator (NDI)), e.g., whether the data in the WTRU buffer is a different (e.g., new) data or is a retransmission of a previously transmitted data; a different behavior for monitoring the corresponding (HARQ) feedback, for example, a (e.g., each) HARQ configuration may be associated with a PDCCH monitoring behavior for HARQ feedback (e.g., slot number and/or monitoring periodicity); different PDU set attributes; etc.

A (e.g., each) HARQ configuration may be associated with a different behavior (e.g., parameter(s) for monitoring the corresponding (HARQ) feedback (e.g., slot number to monitor, monitoring periodicity to use) which the WTRU (e.g., MAC entity in the WTRU) may use to determine the HARQ configuration to apply to the data. For example, for HARQ configuration A, the WTRU may monitor at slot 3 for the HARQ feedback and for HARQ configuration B, the WTRU may monitor at slot 5 for the HARQ feedback. For example, for HARQ configuration C, the WTRU may monitor every 5 ms for the HARQ feedback and for HARQ configuration D, the WTRU may monitor every 10 ms for the HARQ feedback. For example, for HARQ configuration E, the WTRU may start monitoring at slot 2 and may monitor every 5 ms for the HARQ feedback.

A (e.g., each) HARQ configuration may be associated with different PDU set attributes which the WTRU (e.g., MAC entity in the WTRU) may use to determine the HARQ configuration to apply to the data. The different PDU set attributes may include a PSI, for example, a different importance value of the data (e.g., PDU, PDU set, data burst importance). For example, the WTRU may be configured to use HARQ configuration A if the PDU set importance (PSI)>5. The different PDU set attributes may include one or more of the following: an importance of PDU in the PDU set; PDU set type (e.g., PDU set corresponding to an I-frame, PDU set corresponding to a P-frame); PDU set size; PDU set identity (e.g., PDU set #1 may be associated with a higher importance value compared to PDU set #2 and require a different treatment); number of PDUs in PDU set; presence/absence of PSIHI indicator in PDU set; etc.

The WTRU may receive HARQ configuration information (e.g., one or more HARQ configuration(s) from the network as part of an exchange (e.g., initial exchange). Different feedback processes (e.g., HARQ processes) may be associated with different transmissions in parallel. For example, PDU set 2 with PSI=5 may be associated with HARQ configuration A while PDU set 4 with PSI=2 may be associated with HARQ configuration B. In parallel, PDU set A with PSI=2 may be transmitted in inactive state using CG-SDT resources (e.g., as per legacy), e.g., using (e.g., requiring) no feedback mechanism.

The WTRU may (e.g., selectively) buffer data.

The WTRU may (e.g., need to) buffer the transmitted data until the corresponding ACK is received, for example, for the HARQ feedback mechanism to work (e.g., because the data (e.g., PDU set) may be (e.g., need to be) retransmitted in case a NACK is received). The WTRU may retransmit (e.g., send a second indication) the PDU set, for example, if NACK feedback is received (e.g., using the feedback parameters associated with the selected HARQ configuration).

The WTRU may (e.g., only) buffer the transmitted data (e.g., for which it also transmitted an indication of the selected HARQ configuration, as shown in FIG. 4) using the CG-SDT resources, for example, for a selective feedback mechanism in a low power state (e.g., RRC inactive state).

The WTRU may refrain from buffering (e.g., not buffer) PDU sets 1 and 3, for example, if PDU set 1 and PDU set 3 are transmitted (e.g., as per legacy) using CG-SDT resources (e.g., with no feedback mechanism). The WTRU may buffer PDU set 2 (e.g., until the corresponding ACK is received for PDU set 2), for example, if PDU set 2 is transmitted with a feedback request (e.g., via the WTRU indicating the selected HARQ configuration while transmitting PDU set 2).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising:
a processor configured to:
receive configuration information associated with operating in an inactive state, wherein the configuration information indicates a set of thresholds, hybrid automatic repeat request (HARQ) configuration identifications (IDs), and association information, wherein the association information associates each HARQ configuration ID to a respective threshold in the set of thresholds, and wherein each HARQ configuration ID is associated with a respective feedback parameter;
determine a protocol data unit (PDU) set and a value associated with the PDU set;
select, while the WTRU is operating in the inactive state, a HARQ configuration ID based on the value associated with the PDU set, the association information, and the set of thresholds; and
send, to a base station, an indication that indicates the selected HARQ configuration ID and the PDU set.

22. The WTRU of claim 21, wherein the processor is further configured to:
send to the base station the PDU set; and
receive feedback using a first feedback parameter associated with the selected HARQ configuration ID, wherein the feedback is an uplink grant for retransmission in a physical downlink control channel (PDCCH).

23. The WTRU of claim 21, wherein the indication is a first indication, and wherein the processor is further configured to:
receive feedback using a first feedback parameter associated with the selected HARQ configuration ID; and
send a second indication based on the received feedback, wherein the second indication indicates the PDU set.

24. The WTRU of claim 22, wherein the first feedback parameter associated with the selected HARQ configuration ID is a slot number, a monitoring periodicity, or a monitoring duration.

25. The WTRU of claim 21, wherein each threshold in the thresholds is a respective PDU set importance threshold.

26. The WTRU of claim 21, wherein the value associated with the PDU set is an importance value associated with the PDU set.

27. The WTRU of claim 21, wherein the configuration information further indicates a configured grant small data transmission (CG-SDT) resource associated with an inactive state, and wherein the indication is sent using the CG-SDT resource.

28. The WTRU of claim 21, wherein the selected HARQ configuration ID is further based on a property associated with the PDU set.

29. The WTRU of claim 28, wherein the property associated with the PDU set is one of a PDU set type, a PDU set size, or a number of PDUs in the PDU set.

30. The WTRU of claim 21, wherein the processor is further configured to:
monitor for feedback using a first feedback parameter associated with the selected HARQ configuration ID.

31. A method comprising:
receiving configuration information associated with operating in an inactive state, wherein the configuration information indicates a set of thresholds, hybrid automatic repeat request (HARQ) configuration identifications (IDs), and association information, wherein the association information associates each HARQ configuration ID to a respective threshold in the set of thresholds, and wherein each HARQ configuration ID is associated with a respective feedback parameter;
determining a protocol data unit (PDU) set and a value associated with the PDU set;
selecting, while operating in the inactive state, a HARQ configuration ID based on the value associated with the PDU set, the association information, and the set of thresholds; and
sending, to a base station, an indication that indicates the selected HARQ configuration ID and the PDU set.

32. The method of claim 31, wherein the method further comprises:
sending to the base station the PDU set; and
receiving feedback using a first feedback parameter associated with the selected HARQ configuration ID, wherein the feedback is an uplink grant for retransmission in a physical downlink control channel (PDCCH).

33. The method of claim 31, wherein the indication is a first indication, and wherein the method further comprises:
receiving feedback using a first feedback parameter associated with the selected HARQ configuration ID; and
sending a second indication based on the received feedback, wherein the second indication indicates the PDU set.

44. The method of claim 32, wherein the first feedback parameter associated with the selected HARQ configuration ID is a slot number, a monitoring periodicity, or a monitoring duration.

35. The method of claim 31, wherein each threshold in the set of thresholds is a respective PDU set importance threshold.

36. The method of claim 31, wherein the value associated with the PDU set is an importance value associated with the PDU set.

37. The method of claim 31, wherein the configuration information further indicates a configured grant small data transmission (CG-SDT) resource associated with an inactive state, and wherein the indication is sent using the CG-SDT resource.

38. The method of claim 31, wherein the selected HARQ configuration ID is further based on a property associated with the PDU set.

39. The method of claim 38, wherein the property associated with the PDU set is one of a PDU set type, a PDU set size, or a number of PDUs in the PDU set.

40. The method of claim 31, wherein the method further comprises:
monitoring for feedback using a first feedback parameter associated with the selected HARQ configuration ID.
